(19) United States
(12) Patent Application Publication
(10) Pub. No.: US 2025/0156799 A1
(43) Pub. Date: May 15, 2025

(54) TRACKING A TRUCK IN A CONTAINER HANDLING AREA

(71) Applicant: Konecranes Global Corporation, Hyvinkää (FI)

(72) Inventor: Ville MANNARI, Hyvinkää (FI)

(21) Appl. No.: 18/715,564

(22) PCT Filed: Dec. 5, 2022
(86) PCT No.: PCT/FI2022/050808

§ 371 Date: May 31, 2024

(30) Foreign Application Priority Data
Dec. 7, 2021 (FI) 20216247

(51) Int. Cl. G06Q 10/0833; B66C 13/48; B66C 19/00; H04W 4/029; H04W 4/40; H04W 84/04

(52) U.S. Cl. CPC G06Q 10/0833; B66C 13/48; B66C 19/002; H04W 4/029; H04W 4/40; H04W 84/04

(57) ABSTRACT

A method comprising receiving a first indication from a truck indicating that the truck has arrived at a target location, providing a second indication to a container handling vehicle indicating that the container handling vehicle may start executing a task, receiving a third indication from the container handling vehicle indicating that the container handling vehicle is at the target position, receiving a fourth indication indicating that the truck is ready for the truck related part of the task execution, and providing a fifth indication to the container handling vehicle indicating that the container handling vehicle can execute the truck related part of the task execution.

### TECHNICAL FIELD

The present application relates to tracking a truck that is driven by a driver in a container handling area that comprises automated container handling vehicles.

### BACKGROUND

Container handling areas, which may also be called as container handling yards, have developed towards automation such that the need for personnel has been reduced. For example, loading and unloading of containers using container handling vehicles may be automated completely or partially. There are several benefits that may be achieved by automating operations of a container handling area, for example, improved throughput time per one container, improvement of reliability, better predictability, improved safety as there are less people among heavy objects that are being moved, as well as better utilization of the land area available within the container handling area, as traffic jams, lines of vehicles and waiting time of the vehicle in the land area can be reduced. Yet, there are trucks that are driven by a driver that still need to interact with the automated operations of the container handling area when delivering containers or picking up containers to/from a container handling area.

### BRIEF DESCRIPTION

According to an aspect there is provided a method comprising receiving a first indication from a truck indicating that the truck has arrived at a target location, providing a second indication to a container handling vehicle indicating that the container handling vehicle may start executing a task, receiving a third indication from the container handling vehicle indicating that the container handling vehicle is at the target position, receiving a fourth indication indicating that the truck is ready for the truck related part of the task execution, and providing a fifth indication to the container handling vehicle indicating that the container handling vehicle can execute the truck related part of the task execution.

According to an aspect there is provided an apparatus comprising means for receiving a first indication from a truck indicating that the truck has arrived at a target location, means for providing a second indication to a container handling vehicle indicating that the container handling vehicle may start executing a task, means for receiving a third indication from the container handling vehicle indicating that the container handling vehicle is at the target position, means for receiving a fourth indication indicating that the truck is ready for the truck related part of the task execution, and means for providing a fifth indication to the container handling vehicle indicating that the container handling vehicle can execute the truck related part of the task execution.

According to another aspect there is provided an apparatus comprising at least one processor, and at least one memory including a computer program code, wherein the at least one memory and the computer program code are configured, with the at least one processor, to cause the apparatus to receive a first indication from a truck indicating that the truck has arrived at a target location, provide a second indication to a container handling vehicle indicating that the container handling vehicle may start executing a task, receive a third indication from the container handling vehicle indicating that the container handling vehicle is at the target position, receive a fourth indication indicating that the truck is ready for the truck related part of the task execution, and provide a fifth indication to the container handling vehicle indicating that the container handling vehicle can execute the truck related part of the task execution.

According to another aspect there is provided a computer program product which when executed by a computing apparatus causes the apparatus to perform receiving a first indication from a truck indicating that the truck has arrived at a target location, providing a second indication to a container handling vehicle indicating that the container handling vehicle may start executing a task, receiving a third indication from the container handling vehicle indicating that the container handling vehicle is at the target position, receiving a fourth indication indicating that the truck is ready for the truck related part of the task execution, and providing a fifth indication to the container handling vehicle indicating that the container handling vehicle can execute the truck related part of the task execution.

According to an aspect there is provided a computer program product comprising computer program code stored in a non-transitory memory medium, the computer program code being configured to cause an apparatus, when executing the program code by a processor circuitry, to perform at least the following: receive a first indication from a truck indicating that the truck has arrived at a target location, provide a second indication to a container handling vehicle indicating that the container handling vehicle may start executing a task, receive a third indication from the container handling vehicle indicating that the container handling vehicle is at the target position, receive a fourth indication indicating that the truck is ready for the truck related part of the task execution, and provide a fifth indication to the container handling vehicle indicating that the container handling vehicle can execute the truck related part of the task execution.

### BRIEF DESCRIPTION OF THE DRAWINGS

FIG. 1 illustrates an exemplary embodiment of a container handling area.

FIG. 2 illustrates a block diagram according to an exemplary embodiment of an operating management software.

FIG. 3 illustrates an exemplary embodiment of a signalling between a truck, an operating management software and container handling vehicle.

FIG. 4 illustrates an exemplary embodiment of a computing apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

When large objects such as containers are to be moved around and stacked on top of one another, safety of personnel is of major importance. Having vehicles that may perform the moving and stacking autonomously or with minimal guidance performed by a person may therefore be desirable. Examples of such container handling vehicles comprise rail-mounted gantry cranes, rubber-tyred gantry cranes and straddle carriers.

For example, a straddle carrier may be operated without a driver sitting in the straddle carrier. Such straddle carrier may also be called as an autonomous straddle carrier. Straddle carriers may be utilized for example in port terminals and intermodal yards for stacking and moving containers. The containers may be ISO standard compliant. A straddle carrier operates by straddling its load, picking it up and carrying it by connecting to the top lifting points using a container spreader. A straddle carrier may travel at relatively low speeds such as up to 30 km/h or 20 mph.

A gantry crane, in general, may be understood as a crane that is built atop a gantry. Gantry cranes may vary from gantry cranes, capable of lifting some of the heaviest loads in the world, to small cranes such as cranes capable of lifting automobile engines out of vehicles. The structure of a gantry crane may be on wheels. The wheels may be rubber tyred wheels or the wheels may be on rails. A straddle carrier may be considered as one type of a rubber-tyred gantry crane.

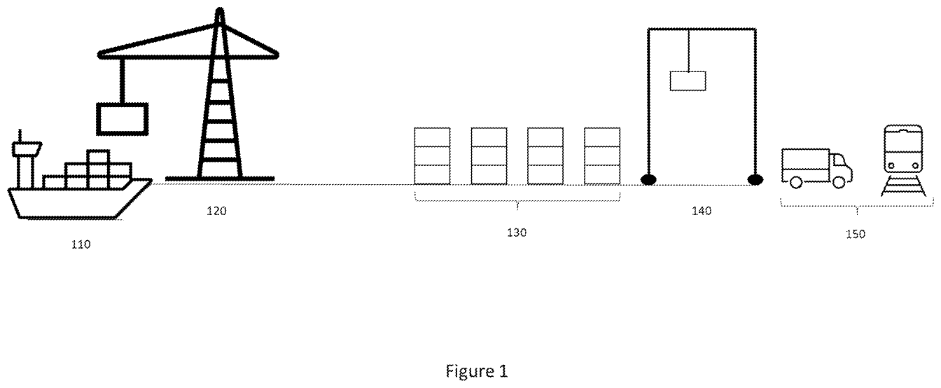

FIG. 1 illustrates an exemplary embodiment of a container handling area, that is a geographically limited area, in which a container handling vehicle may be utilized. It is to be noted that the layout of the container handling area may vary and in this exemplary embodiment, the layout is simplified for the sake of ease of explanation. The environment in this exemplary embodiment is a port in which container ships may be loaded and unloaded of containers. In this exemplary embodiment a container ship 110 is being unloaded by a ship-to-shore crane 120 after which the containers 130 may be stacked to a dedicated stacking area in the port. A container handling vehicle 140, that in this exemplary embodiment is a rubber-tyred gantry crane, may then be utilized when individual containers are loaded on to a truck or train 150. In the container handling area, there may be a dedicated area for trucks such that loading and/or unloading of trucks takes place at the dedicated place to which a container handling vehicle brings a container and loads it, or at which the container handling device unloads a container from a truck. This way the trucks do not operate among the containers and container handling vehicles more than is necessary.

In a container handling area, such as a port, there may be a plurality of container stacks and a plurality of container handling vehicles that are operating and moving around at the same time. In order to improve efficiency and safety, automatization may be utilized for operating the container handling area that comprises moving and storing containers as well as loading and unloading them to vehicles. Thus, there needs to be overall planning and guidance applying to the operation to avoid collisions and to make sure that correct vehicle is in a correct place at the correct time and handling the correct container in a correct manner. To achieve this an operating management software may be utilized. The operating management software may comprise one or more software programs that together then enable controlling of the operations taking place in the container handling area that may be at least partly automated. It is to be noted that there may be a user that interacts with the operating management software. The overall management of the operations of the container handling area may comprise for example task planning, task scheduling, routing and onboarding aspects that are managed and controlled. The task planning may comprise plans regarding unloading a container ship. This planning may be performed by software program without user input or with some user input. A task may comprise identifying a container and its destination in the storage area. The tasks may then be scheduled using software. The software may independently schedule the tasks or user input may be provided to complete scheduling of the tasks. Scheduling may comprise assigning a container handling vehicle to a task. The scheduling may take into account aspects such as timing, locations of the container handling vehicles and job queues associated with the container handling vehicles. When planning routing, an optimized route for each of the container handling vehicle may be determined by the software with or without user input. When determining the routes, aspects such as currently assigned tasks to each container handling vehicle and their current locations may be taken into account. At an onboarding stage, a container handling vehicle may then execute a task and move a container from its current location to its target location. The container handling vehicle may perform this part autonomously. Autonomous performing of the task may however comprise a user guiding from a distance the container handling vehicle. Yet, in an autonomous performance of the task the container handling vehicle operates without a driver in it.

As a part of an operating management software there may be a terminal operating system, TOS. In an exemplary embodiment, the TOS functionalities may comprise controlling of transfer points, controlling of container distribution between blocks and of container positions within the blocks and submitting tasks and obtaining status of control handling vehicle. It is to be noted that functionality comprised in TOS may vary in different embodiments. The operating management software may be connected to container handling vehicles that operate in the container handling area. The container handling vehicles may comprise software that performs functions such as receiving, checking and confirming tasks, calculating a route for performing a task, controlling movements of the container handling vehicle, monitoring for collisions and taking necessary measures to avoid collisions and preventing deadlocks. The software of the container handling vehicle may then communicate with the operating management software and report outcomes of its functions and also receive commands and indications from the operating management software. Additionally, or alternatively, in some exemplary embodiments, there may further be an equipment control system, ECS, comprised in the control management software. ECS is a software module that may be shared by a plurality of container handling vehicles that may be automated container handling vehicles. ECS may comprise functionality such as coordinating operations of a group of container handling vehicles. For example, if there are multiple container handling vehicles, that may be automated, operating on same tracks or pathways within a container handling area, then ECS may be utilized to coordinate operations of the container handling vehicles. The ECS may communicate with TOS. In some exemplary embodiments, dedicated messaging may be used for the communication between the ECS and TOS. The communication may comprise for example submitting and confirming tasks, which may also be understood as work orders, updating locations of container handling vehicles and their status, conclusion or interruption of an operation and status information regarding the container handling area.

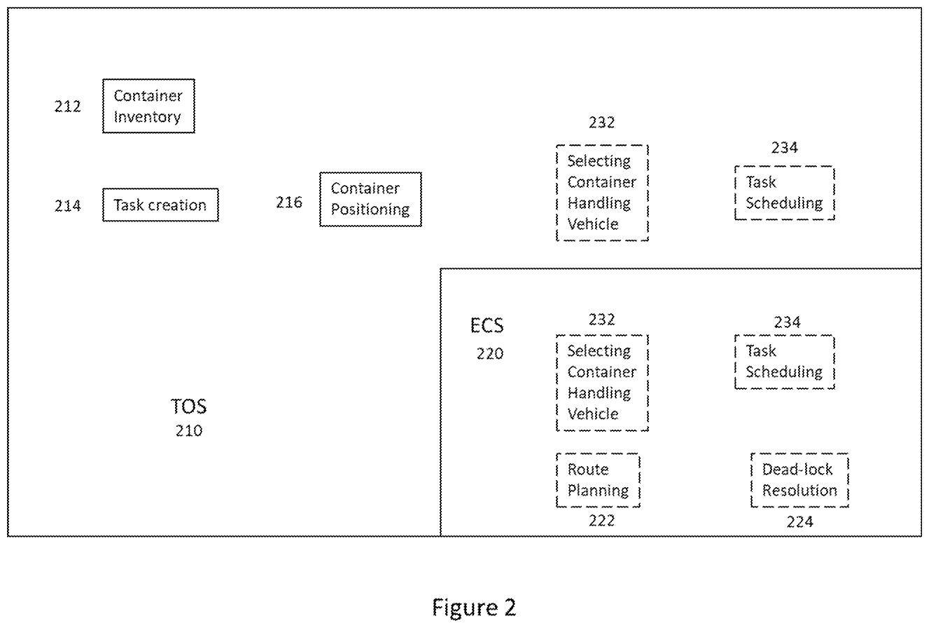

FIG. 2 illustrates an exemplary embodiment of operating management software using a block diagram for the illustration. In this exemplary embodiment the operating management software comprises a TOS 210 and an ECS 220. The operating management software may further communicate with one or more container handling vehicles, that may be automated. Communication may be between the ECS 220 and a container handling vehicle and/or between the TOS 210 and a container handling vehicle. In this exemplary embodiment, the TOS 210 comprises a software module for container inventory 212 that keeps track of the containers within the container handling area. This may comprise keeping track of container moves that are reported by container handling vehicles operating in the container handling area. The TOS 210 also comprises a software module for task creation 214 and a software module for container positioning 216 that may be used for positioning planning in the container handling area.

The ECS 220 comprises a software module for route planning 222 and a software module for dead-lock resolution 224. There are functions that may be performed by a software module comprised in the ECS 220 or by a software module comprised in the TOS 210 or by a combination of both. Such functions are selecting a container handling vehicle for executing a task 232 and task scheduling 234.

If a container handling area is at least partly automated, with automated container handling vehicles, and operating management software is utilized, there may no longer be a person operating a container handling vehicle who would see a truck arriving to pick up or to deliver one or more containers. Thus, it is desirable to avoid a situation in which a truck is delivering a container to a location in the container handling area where there is no container handling vehicles nearby or there is no one operating a container handling vehicle who would notice the truck. Therefore, the operating management software is to be aware of trucks arriving to the container handling areas and to be able to track and/or guide the movement of the arriving and departing trucks.

A truck that is visiting the container handling area to pick up or drop-off may be tracked using various tracking methods. For example, satellite-based positioning such as GPS may be utilized. The GPS may be detected from a module comprised in the truck itself or from the driver's device such as mobile phone for example. The positioning accuracy may vary, however, in some exemplary embodiments, the accuracy is to be +/−50 meters. Alternatively, or additionally, the truck may also be tracked using for example one or more cameras. Such one or more cameras may be installed for example at a gate area of the container handling area and/or on a drone that can then be flown around the controller handling area. Based on the image data received from the one or more cameras, it can be recognized that the truck is approaching the container handling area and/or follow how the truck is moving within the controller handling area. Further, based on the image data received from the one or more cameras, a plurality of trucks can be detected and individually recognized. The position of the truck may then be indicated to a TOS, such as the TOS 210, once the truck is approaching the container handling area. The TOS may then transmit to the truck, or to a device connected to the truck such as the driver's mobile phone, indications that may be output to the driver using for example visual and/or audio output. In other words, the truck or a device connected to the truck may be able to communicate with the TOS of the container handling area. For example, the TOS may be configured to obtain a connection to the truck, or to the device connected to the truck, as soon as the truck is close enough to the container handling area such that the signals provided by the TOS reach the truck, in other words, the truck is within a coverage area of a network the TOS uses to provide signals. The TOS may further transmit requests to the truck such as providing an indication once the truck is at a certain location or regarding the status of the truck. Also, the TOS may be in contact with the truck continuously as the truck approaches and/or enters the container handling area. It is to be noted that the device connected to the truck may comprise an application that is capable of connecting to the TOS and to provide output such as a visual, audio and/or haptic output. The device may be any suitable mobile device. It is to be noted though that in some exemplary embodiments the device may be comprised in the truck. If the device is comprised in the truck, it may be an integral part of the truck.

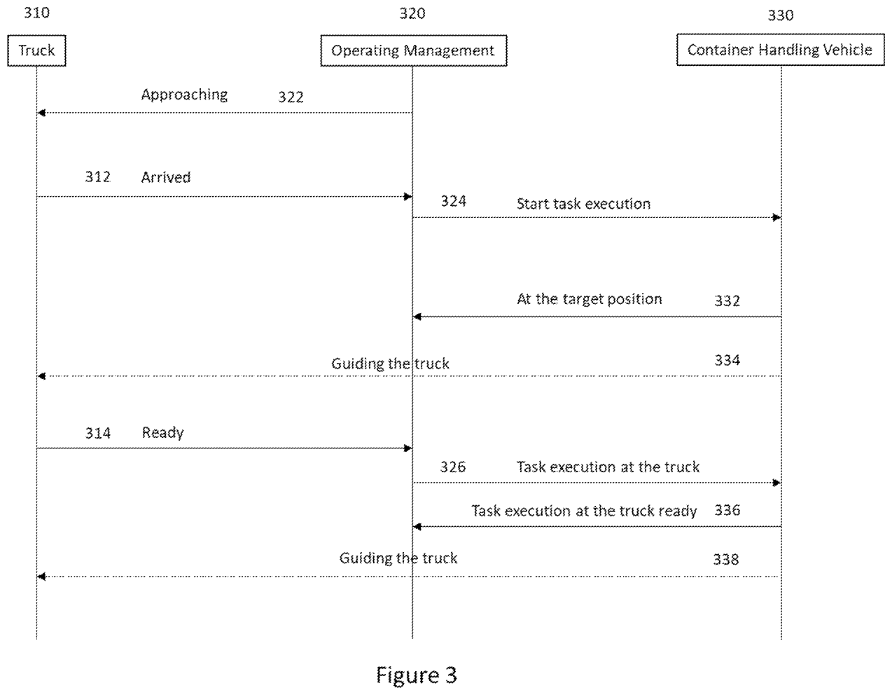

FIG. 3 illustrates a signalling chart according to an exemplary embodiment. The signalling may be understood as transmitting indications between a truck 310 that is visiting a container handling area, an operating management software 320, and an automated container handling vehicle 330. The operating management software 320 may comprise a TOS and an ECS. In this exemplary embodiment, the operating management software 320 receives an indication of the position of the truck 310 continuously once the truck is closer than a pre-determined threshold distance, such that the coverage area of the network used by the operating management software 320, to the container handling area. Optionally, in some exemplary embodiments, the truck 310 may be informed, when it is approaching the container handling area, of the status of the container handling area. The status may indicate how busy the container handling area is and also when would be an optimal time slot for the truck 310 to arrive to the container handling area. For example, the number of trucks allowed simultaneously in the container handling area may be limited.

As an example, the operating management software 320 may determine an estimation of a time of an arrival for trucks that are approaching the container handling area. The estimation of the time of arrival of a truck may be based on the operating management software having a contact to the truck, that is approaching, and using the contact, determining the speed and distance of the truck. It is to be noted though that the exact place of the truck at a given time may not be necessary to determine, when the truck is outside the container handling area. This may be beneficial for example if local privacy regulations are to be followed.

As a further example, the operating management software 320 may determine a list of tasks related to different trucks. The tasks are assigned to the list based on the estimated times of arrival of the trucks as well as based on the actual times of arrival of the trucks. The tasks may also be rearranged within the list. For an approaching truck, based on the place the task associated with the approaching truck has in the list of tasks, the operating management software 320 may inform the approaching truck regarding for example one or more of the following aspects determined for the approaching truck: the waiting area reserved, the waiting time estimated, the lane, the place of the loading container handling vehicle and its identifier(s) such as the name of the container handling vehicle and/or its number. It is to be noted though that the waiting area may be outside or inside the container handling area.

Once the truck 310 then approaches the container handling area, for example when the truck 310 identifies itself to be allowed to the container handling area, the operating management software 320 may provide the truck 310 an indication 322 of the target location within the container handling area to which the truck 310 should go to for unloading and/or loading. The truck 310 may also be requested to provide an indication 312 when it has arrived at the target location. The indication may comprise, additionally, information regarding the location of the truck, a location of a mobile device associated with the driver of the truck and/or image data received from one or more cameras based on which the truck is recognized. In some exemplary embodiments, such indication may only be accepted by the operating management software 320 after the operating management software 320 has provided the indication 322 of the target location. The indication 322 of the target location may be such that it requires the driver of the truck 310 to provide a user input such as pressing a button, that may be a physical button at the area of the target location and/or a virtual button on a display such as the display of a mobile device and/or any other suitable means for providing user input. Requiring the user input to be provided may be beneficial as it ensures a person has verified that the indication 312 may indeed be provided. Further, additionally or alternatively, the confirmation may also be done using data obtained from one or more cameras and based on the data, using image recognition to identify a license plate of the truck. Further, additionally or alternatively, when the truck arrives at the gate of the container handling area, any suitable object recognition could be utilized to recognize the truck and thereby then automatically provide the confirmation when the truck is at the target location.

After the truck 310 has provided the indication 312 that it has arrived at the target location to the operating management software 320, an indication 324 to start a task may be provided by the operating management software 320 to the automated container handling vehicle 330. The task may comprise loading or unloading the truck 310 and moving one or more containers accordingly. The container handling vehicle 330 may then approach the truck 310 in accordance with the task. Once the container handling vehicle 330 has arrived at the target location, an indication 332 may be provided by the container handling vehicle 330 to the operating management software 320 indicating that the container handling vehicle 330 has arrived at the target location. Next, optionally, the container handling vehicle 330 may initiate a process of guiding the truck 310 to a position that is exactly right in relation to the container handling vehicle 330. This may be done for example by using lights to guide the truck and it may be similar to carwash machines. The container handling vehicle may comprise sensors and/or cameras that may be used to detect the truck 310 and to know when the truck is in the exact correct place. This guidance may have the benefit of avoiding the container handling vehicle 330 having to move further as the truck 310 is already in the correct location, or alternatively, merely minor fine positioning of the container handling vehicle 330 is required. Alternatively, the guiding process may be initialized by the operating management software 320.

Once the truck 310 is in the correct position, the truck may provide an indication 314 that it is ready for the task to be executed by the container handling vehicle 330. It is to be noted that for safety reasons, the driver must not be in the truck when the container handling vehicle 330 performs the task with regard to the truck 310. Thus, to ensure the safety of the driver, the operating management software 320 is to receive an indication indicating that the driver of the truck 310 is in a safe place, such as a marked position outside the truck 310 and the position of the truck or in a shelter that is for the driver to stay in during the execution of the task by the container handling vehicle 330. From the safe place the driver may then provide the indication by pushing a physical button located at the safe place for example. This indication may additionally be used to indicate that the truck 310 is in a correct place and will no longer be moving lengthwise. Before providing the indication, the driver may have prepared the truck 310 for the task to be executed by the container handling vehicle 330 by for example preparing the locks of the truck 310 for loading or unloading a container. After receiving the indication 326 the container handling vehicle 330 may then proceed to handle one or more container to or from the truck 310. In some exemplary embodiments, there may be an additional requirement that a continuous indication that the driver is not in the truck is to be received during the execution of the truck related part of the task, in other words, during loading or unloading of one or more containers. The continuous indication may be received for example from a button press a user makes outside the truck using for example the physical button that has a known location outside the truck 310, the safe place, and the area at which the container handling vehicle 330 operates. The duration of the continuous indication may be a required to be as long as the execution of the truck related part of the task or it may be pre-determined time period that is long enough to ensure that the driver is not inside the truck 310 while the execution of the truck related part of the task is ongoing. Further, alternatively or additionally, after a single push of a button the driver may be followed using suitable optical means, for example camera, to monitor the driver and ensuring he is not leaving the safety zone.

Once the truck related part of the task has been executed by the container handling vehicle 330, the container handling vehicle 330 may provide an indication 336 to the operating management software 320 indicating that the task execution at the truck 310 is completed. In some exemplary embodiments, a corresponding indication may be provided to the driver as well. The indication to the driver may be provided in any suitable means, for example by transmitting it to a mobile device associated with the driver or providing it to a suitable device at the safe location. Optionally, the container handling vehicle 330 may also guide the truck 310 to leave the loading/unloading area of the container handling area. Further, optionally, there may also be a possibility for the truck 310 to leave the position without a completion of the task. For example, in case the truck 310 has a flat tire or the locks are not working correctly, upon detecting such a malfunction an indication regarding the malfunctioning may be provided at least to the operating management system. This may then cause the task execution to be cancelled and the truck 310 may then exit without the task to be executed by the container handling vehicle 330 to be completed.

Thus, as a general example, the operating management software 320 may monitor the place of a truck as it is being loaded or unloaded and ensure that the truck stays in its place and does not move during the loading or unloading. Further, the operating management software 320 may be configured to ensure using any suitable means that during the loading or unloading the driver of the truck is in the cabin of the truck or is away from the cabin of the truck. Once the loading or unloading is completed, the operating management software 320 may provide information regarding the loading or unloading to the truck itself and the operating management software 320 may continue to follow the truck until it has left the container handling area. It is to be noted that providing the information regarding the loading or unloading may comprise providing two different pieces of information. First, there may be a confirmation provided that the loading or unloading has occurred. The confirmation may be provided to the operating management software 320 as well as to the truck. Then there may be information provided regarding payload itself. The information regarding the payload itself may be provided to the truck, by the operating management software 320, in the context of loading, or the truck may provide the information regarding the payload itself to the operating management software 320 in the context of unloading. The information regarding the payload itself may comprise for example content of the payload, identifier of the container, mass, length of the container, storing temperature, place of departure, destination, and/or information for customs. These operations described above may be performed continuously by the operating management software 320.

A truck and a container handling vehicle may communicate with an operating management software using any suitable wireless network. An example of such a wireless network is long range wide area network, LoRaWAN that may be used for example with IoT and low power sensors. LoRaWAN access points may have range of some kilometers and therefore a container handling area may be covered with a few LoRaWAN access points. A further benefit of LoRaWAN is that it may also provide positioning information. Another example of how to provide positioning information is by using GPS as already described above. Further, alternatively or additionally, one or more cameras may also be utilized for obtaining positioning information as also described above.

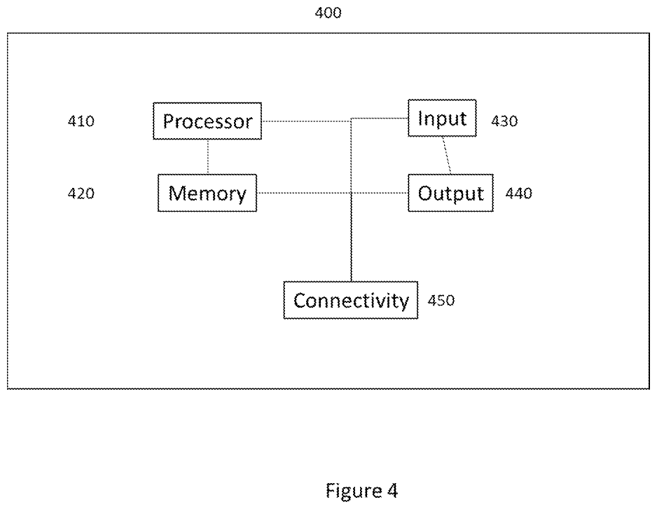

The apparatus 400 illustrated in FIG. 4 is an exemplary embodiment of a computing apparatus that may be comprised in a mobile device, in a truck, in a container handling vehicle and which may be comprised in hardware used to running operating management software. The apparatus 400 comprises a processor 410. The processor 410 interprets computer program instructions and processes data. The processor 410 may comprise one or more programmable processors. The processor 410 may comprise programmable hardware with embedded firmware and may, alternatively or additionally, comprise one or more application specific integrated circuits, ASICs.

The processor 410 is coupled to a memory 420. The processor is configured to read and write data to and from the memory 420. The memory 420 may comprise one or more memory units. The memory units may be volatile or non-volatile. It is to be noted that in some example embodiments there may be one or more units of non-volatile memory and one or more units of volatile memory or, alternatively, one or more units of non-volatile memory, or, alternatively, one or more units of volatile memory. Volatile memory may be for example RAM, DRAM or SDRAM. Non-volatile memory may be for example ROM, PROM, EEPROM, flash memory, optical storage or magnetic storage. In general, memories may be referred to as non-transitory computer readable media. The memory 220 further stores computer readable instructions that are execute by the processor 410. For example, non-volatile memory stores the computer readable instructions and the processor 410 executes the instructions using volatile memory for temporary storage of data and/or instructions. The memory may also save data such as values.

The computer readable instructions may have been pre-stored to the memory 420 or, alternatively or additionally, they may be received, by the apparatus, via electromagnetic carrier signal and/or may be copied from a physical entity such as computer program product. Execution of the computer readable instructions causes the apparatus 400 to perform functionality described above.

In the context of this document, a memory or computer-readable media may be any non-transitory media or means that can contain, store, communicate, propagate or transport the instructions for use by or in connection with an instruction execution system, apparatus, or device, such as a computer.

The apparatus 400 further comprises, or is connected to, an input unit 430. The input unit 430 comprises one or more interfaces for receiving a user input. The one or more interfaces may comprise for example one or more motion and/or orientation sensors, one or more cameras, one or more accelerometers, one or more microphones, one or more buttons and one or more touch detection units. Further, the input unit 430 may comprise an interface to which external devices may connect to.

The apparatus 400 also comprises an output unit 440. The output unit may comprise for example one or more displays capable of rendering visual content such as a light emitting diode, LED, display or a liquid crystal display, LCD. The output unit 440 may further comprise one or more audio outputs such as loudspeakers or a set of headphones.

The apparatus 400 may further comprise a connectivity unit 450. The connectivity unit 450 enables wired and/or wireless connectivity to external networks such as Bluetooth or Wi-Fi. The connectivity unit 450 may comprise one or more antennas and one or more receivers that may be integrated to the apparatus 400 or the apparatus 400 may be connected to. The connectivity unit 450 may comprise an integrated circuit or a set of integrated circuits that provide the wireless communication capability for the apparatus 400. Alternatively, the wireless connectivity may be a hardwired application specific integrated circuit, ASIC.

It is to be noted that the apparatus 400 may further comprise various component not illustrated in the FIG. 4. The various components may be hardware component and/or software components.

Even though the invention has been described above with reference to exemplary embodiments according to the accompanying drawings, it is clear that the invention is not restricted thereto but can be modified in several ways within the scope of the appended claims. Therefore, all words and expressions should be interpreted broadly, and they are intended to illustrate, not to restrict, the embodiment. It will be obvious to a person skilled in the art that, as technology advances, the inventive concept can be implemented in various ways. Further, it is clear to a person skilled in the art that the described exemplary embodiments may, but are not required to, be combined with other exemplary embodiments in various ways. The scope of protection sought for various embodiments of the invention is set out by the independent claims. If any exemplary embodiments and features described in this specification should not fall under the scope of the independent claims, those are to be interpreted as examples useful for understanding various embodiments of the invention.

1. A method comprising:
receiving a first indication from a truck indicating that the truck has arrived at a target location;
providing a second indication to a container handling vehicle indicating that the container handling vehicle may start executing a task;
receiving a third indication from the container handling vehicle indicating that the container handling vehicle is at the target position;
receiving a fourth indication indicating that the truck is ready for the truck related part of the task execution; and
providing a fifth indication to the container handling vehicle indicating that the container handling vehicle can execute the truck related part of the task execution.

2. The method according to claim 1 wherein the first indication is rejected if prior to receiving the first indication a prior indication indicating that the target location to the truck has not been provided or if the truck fails to arrive at the target location within a predetermined time.

3. The method according to claim 1 further comprising receiving a sixth indication from the container handling vehicle indicating that the truck related part of the task has been executed.

4. The A method according to claim 1 wherein the fourth indication comprises a continuous indication obtained from a driver of the truck.

5. The method according to claim 4, wherein the continuous indication is an indication that has a pre-determined duration.

6. The method according to claim 1, wherein the fifth indication is provided after the fourth indication is received.

7. The method according to claim 1, wherein the truck may comprise a device connected to the truck.

8. The method according to claim 1, wherein the indications are transmitted using a wireless network.

9. The method according to claim 8, wherein the wireless network is a LoRaWAN.

10. The method according to claim 1, wherein the container handling vehicle is an automated container handling vehicle.

11. The method according to claim 10, wherein the automated container handling vehicle is an automated rubber tyred gantry crane.

12. The method according to claim 1, wherein the method further comprises tracking the location of the truck.

13. The method according to claim 1, wherein the task comprises loading a container to the truck or unloading a container from the truck.

14. The method according to claim 1, wherein the first indication comprises information regarding the location of the truck, a location of a mobile device associated with the driver of the truck and/or image data received from one or more cameras based on which the truck is recognized.

15. An apparatus comprising means for performing a method according to claim 1.

16. A computer program product which, when executed by a computing apparatus, causes the apparatus to perform a method according to claim 1.
